(19) United States
(12) Patent Application Publication
(10) Pub. No.: US 2021/0013784 A1
(43) Pub. Date: Jan. 14, 2021

(54) ELECTROMAGNETIC DEVICES

(71) Applicant: EPROPELLED LIMITED, Cardiff (GB)

(72) Inventor: Nabeel Ahmed Shirazee, Cardiff (GB)

(21) Appl. No.: 16/968,865

(22) PCT Filed: Feb. 12, 2019
(86) PCT No.: PCT/GB2019/050367

§ 371 Date: Aug. 10, 2020

(30) Foreign Application Priority Data
Feb. 12, 2018 (GB) 1802254.1

(51) Int. Cl. H02K 15/085; H02K 3/26; H02K 3/28; H02K 15/10; H02K 15/00; H02K 15/02

(52) U.S. Cl. CPC H02K 15/085; H02K 3/26; H02K 15/02; H02K 15/105; H02K 15/0068; H02K 3/28

(57) ABSTRACT

A method of forming an electrical motor, generator or other electromagnetic device by 3-D printing, wherein layers e.g. 24c-24s are successively deposited which comprise conductive regions and regions of a laminated, core, yoke or other former (11), so as to build up a plurality of conductors (12) extending inside spaces (26) in the former (11). The conductors (12) are interconnected at their ends to form a winding-like structure in or around the former (11) or a part thereof. The method enables each space (26) available in the former (11) to be filled with conductors (12), thereby maximising the efficiency of the device.

This invention relates to electromagnetic devices and more particularly, but not solely, to electrical machines such as motors and generators.

Billions of electromagnetic devices, such as solenoids, transformers, coils, inductors, chokes, motors and generators are manufactured each year. The majority of such devices have electrical windings in the form of insulated conductors, which are wound around rotor laminations, stator laminations, cores, yokes or other formers. In many such devices, the conductors are wound in voids or so-called slots. The fill factor of an electromagnetic device is defined as the ratio of the combined cross-sectional area of all conductors (excluding any insulation) in a void to the cross-sectional area of the void.

Ideally, the insulated conductors should completely fill the available void area, but a high fill factor is never achieved due to mismatches between the cross-sectional shape of the insulated conductor and/or the cross-sectional shape of the void. Accordingly, most electromagnetic devices have a poor fill factor and comprise airgaps that extend between the insulated conductors and adjacent insulated conductors and/or the side walls of the slot. In some electromagnetic devices, windings are used without formers, yokeless, but such devices still suffer the same or similar issues when wound.

Electromagnetic devices with a high fill factor are difficult and costly to produce because the windings have to be densely packed, which is time consuming. Machines are known for inserting windings into voids. However, this process produces longer end windings with increased winding resistance and requires additional space. Typically, the void fill factor is around 40 to 50% and, in some high fill factor cases, it is around 60% to 70%. Once such high fill factor winding is the so-called Hairpin winding used in motors and generators, in which the windings resemble individual hairpins and are typically made from rectangular wires, which are pushed into the lamination slots from one end. The hairpin ends are soldered to complete the winding. This method is complex and has many joints. If the joints are subjected to continuous high vibration it could lead to reliability issues.

CN107170564, DE102013214128 and JPH05283259 disclose a method of forming an electromagnetic device, the method comprising depositing successive layers, each deposited layer comprising a plurality of conductive regions of said conductive material which are electrically isolated from each other and which form portions of respective conductors of the device, each conductive region of each successive layer at least partially overlying the conductive region of the respective conductor in the adjacent layer and being in electrical and mechanical contact therewith to form a plurality of elongate conductors which are electrically isolated from each other.

In accordance with the present invention, as seen from a first aspect, there is provided a method of the kind disclosed in CN107170564, DE102013214128 and JPH05283259 for forming an electromagnetic device, the method being characterised in that each layer further comprises at least one region of a former material which is electrically isolated from the conductive regions, each region of former material of each successive layer overlying the respective region of former material in an adjacent layer and being in mechanical contact therewith to form an elongate former which is electrically isolated from the conductors and which co-extends with the conductors.

The method of the present invention comprises depositing layers having respective regions formed of conductive and former material, so that the conductors and the former are simultaneously formed in layers by deposition. The shape of each conductive region can be configured, so that it lies as close as possible to adjacent conductive regions. The method of the present invention also enables the shape of conductive regions to be configured, so as to fit as closely as possible within slots or other voids formed by the deposited former regions. In this manner airgaps are minimised and the density of conductors in the available space is maximised.

The method may comprise depositing said successive layers, each layer comprising said plurality of conductive regions and at least one region of a former material which is electrically isolated from the conductive regions, each region of former material of each successive layer overlying the respective region of former material in the adjacent layer and being in mechanical contact therewith to form an elongate former which is electrically isolated from the conductors and which co-extends with the conductors. In this manner the conductors and the former are simultaneously formed by deposition.

The regions of a layer may be deposited to have equal cross-sectional areas to at least some of the other regions in that layer.

The ends of some conductors may be interconnected to the ends of other conductors by interconnections to form turns of the electromagnetic device which are analogous to the windings of a traditional wound electromagnetic device. The interconnections may be formed by depositing successive layers, each layer comprising a plurality of regions of said conductive material which are electrically isolated from each other and which form portions of respective interconnections of the device, each region of each successive layer overlying the region of the respective interconnection in the adjacent layer and being in electrical and mechanical contact therewith to form a plurality of interconnections which are electrically isolated from each other and electrically connected to an end of at least one elongate conductor.

The ends of some conductors may be connected to wires, terminals or other connections which convey current to and/or from the conductors. The connections may be formed by depositing successive layers, each layer comprising a plurality of regions of said conductive material which are electrically isolated from each other and which form portions of respective connections of the device, each region of each successive layer overlying the region of the respective connection in the adjacent layer and being in electrical and mechanical contact therewith to form a plurality of connections which are electrically isolated from each other and electrically connected to an end of at least one elongate conductor.

Each layer may be deposited to provide at least one space within which no material is deposited, each space of each successive layer overlying the respective space in the adjacent layer to form an elongate void which co-extends with the conductors. The void may act as a cooling channel or may serve to insulate adjacent conductors.

A separate former member may be inserted into the or each void. The separate former member may comprise a plurality of portions which extend into respective voids. The connections and/or interconnections may be formed after the separate former member has been inserted into the or each void.

The former may be laminated and formed by successively depositing layers of a first former material and layers of a second former material to form a laminated structure. The first former material may be a ferromagnetic material and the second material may be an insulative material.

The former material may be treated, for example by a magnetic field and/or by laser scribing, to align or refine the magnetic domains and or the grains in a preferred magnetic circuit direction. This process reduces core losses and greatly increases the efficiency of the device.

The method may comprise depositing a plurality of soft magnetic materials with varying magnetic properties in respective regions of the former. For example, in an electrical machine, the tips of teeth of the former can be formed using an expensive material having a high saturation flux density, a body of the teeth can be formed with another mixed material and the rest of the former with inexpensive material, thereby forming a hybrid former.

The method may comprise depositing said successive layers, each layer comprising said plurality of conductive regions, each conductive region being surrounded by an insulative region of insulative material which electrically isolates each conductive region from adjacent regions in the layer, each insulative region of each successive layer overlying the respective insulative region in the adjacent layer to form an insulative surround around each conductor.

The layers may be deposited by 3-dimensional printing and/or by vapour deposition. Effectively, a multi head machine can “print” the complete electromagnetic device machine including all of the plastic, metallic and magnetic components. Some parts can be formed using carbon fibre or Kevlar filaments for added strength.

Different conductive materials may be deposited. The current density may be varied by selectively depositing stanene, silver, copper or gold, and the weight may be varied by selectively depositing copper and/or aluminium.

The method may comprise depositing said successive layers, each layer comprising said plurality of conductive regions and at least one wall region of a material which surrounds a space, each walled region of each successive layer overlying the respective walled region in the adjacent layer to form a duct. In use, a coolant fluid can be passed along the duct. The walled region may act as former.

The method may be a method of forming an electrical machine having and axis of rotation, the layers being successively deposited in the direction of the axis of rotation of the machine.

The above method allows the windings of the kind disclosed in WO2005043740 to be deposited to provide a plurality of winding configurations for electrical motors and generators.

An advantage of the invention is that the phase winding resistance will be the same in each phase. This is not always the case in a traditionally-wound electric machines leading to phase imbalances and unwanted circulating currents.

In accordance with the present invention, as seen from a second aspect, there is provided a method of forming an electromagnetic device, the method comprising depositing successive layers, each deposited layer comprising at least one region of a former material, each region of former material of each successive layer overlying the respective region of former material in the adjacent layer and being in mechanical contact therewith to form a former of the device, a coil then being disposed around the former.

The former may be formed by depositing layers of a first former material and layers of a second former material to form a laminated structure. The first former material may be a ferromagnetic material and the second material may be an insulative material.

The former material may be treated, for example by a magnetic field and/or by laser scribing, to align or refine the magnetic domains and or the grains in a preferred magnetic circuit direction. This process reduces core losses and greatly increases the efficiency of the device.

The method may comprise depositing a plurality of soft magnetic materials with varying magnetic properties in respective regions of the former. For example, in an electrical machine, the tips of teeth of the former can be formed using an expensive material having a high saturation flux density, a body of the teeth can be formed with another mixed material and the rest of the former with inexpensive material, thereby forming a hybrid former.

Embodiments of the present invention will now be described by way of examples only and with reference to the accompanying drawings, in which:

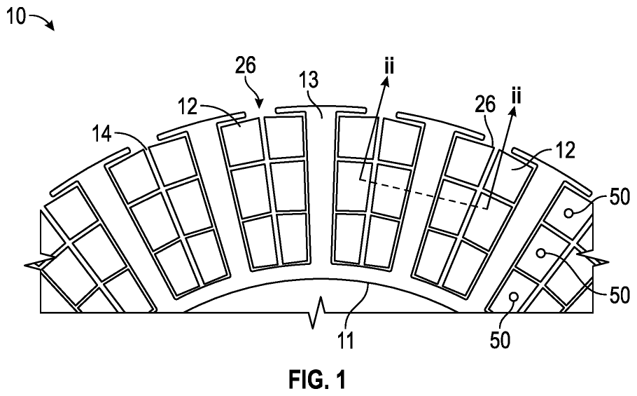

FIG. 1 is a cross-sectional view through a stator of a motor formed in accordance with the present invention;

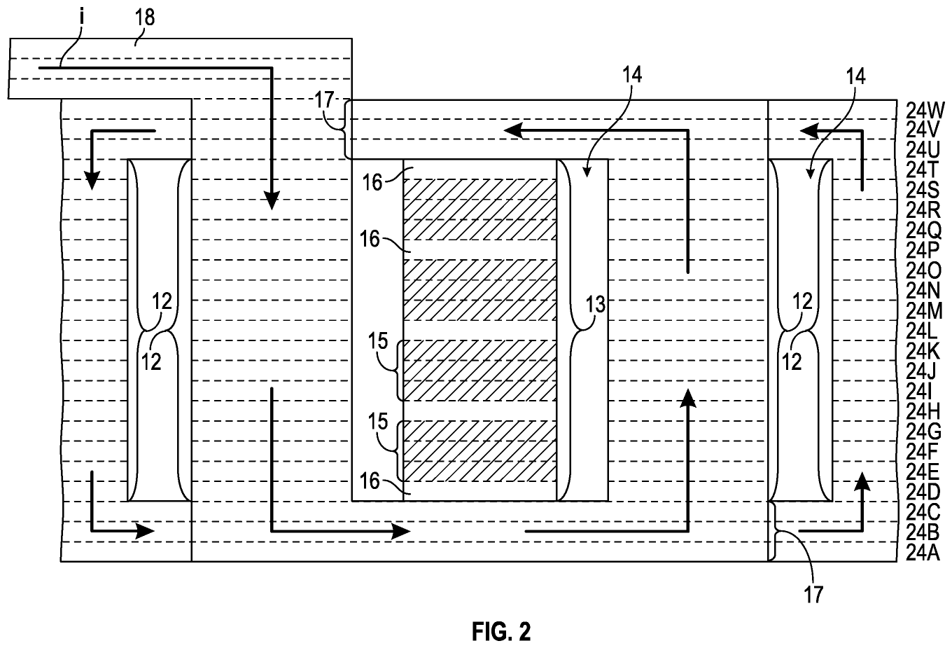

FIG. 2 is a sectional view along the line ii-ii of FIG. 1;

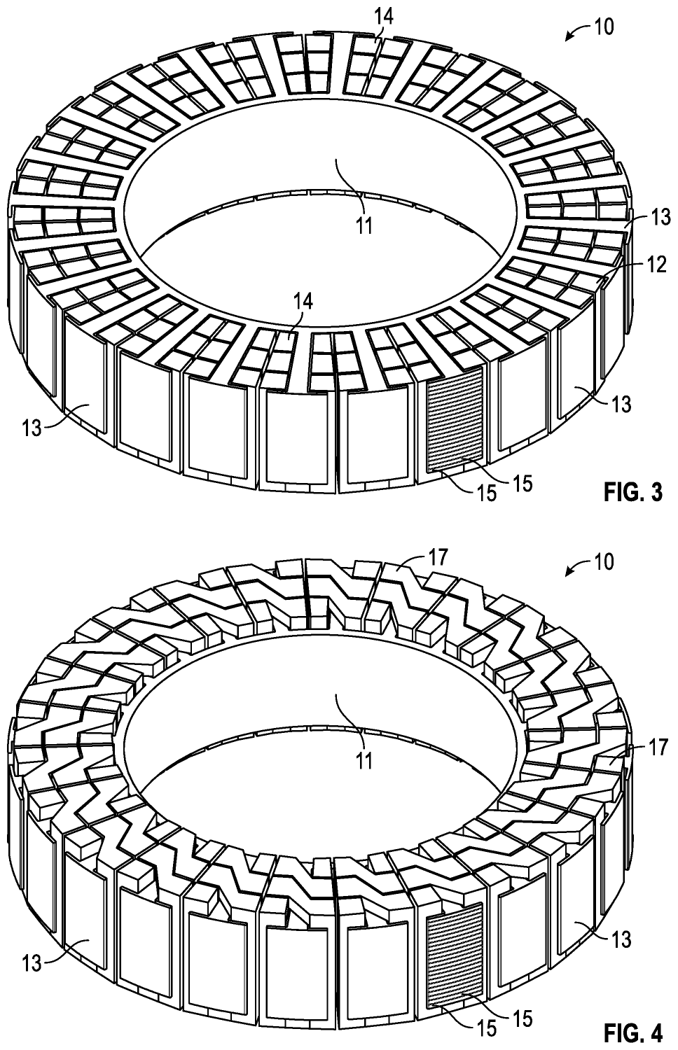

FIG. 3 is a perspective view of the stator of FIG. 1, when partly formed;

FIG. 4 is a perspective view from above of the stator of FIG. 1;

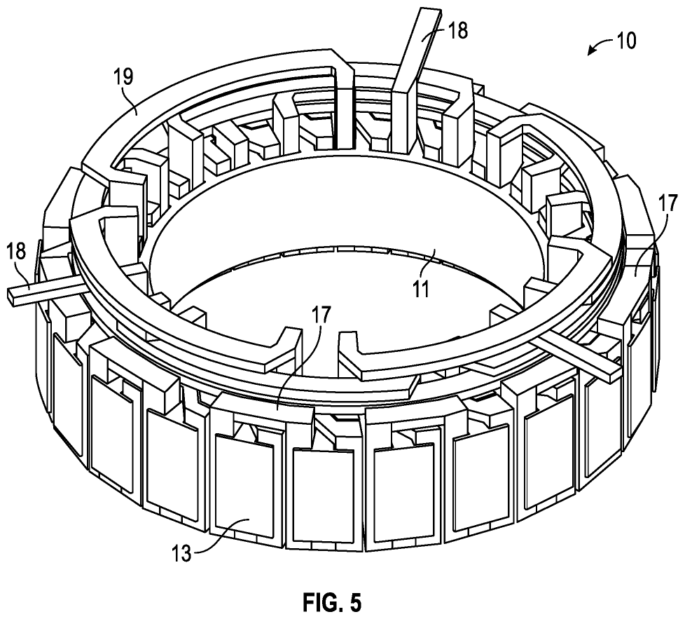

FIG. 5 is a perspective view from above of the stator of FIG. 1, showing interconnections; and

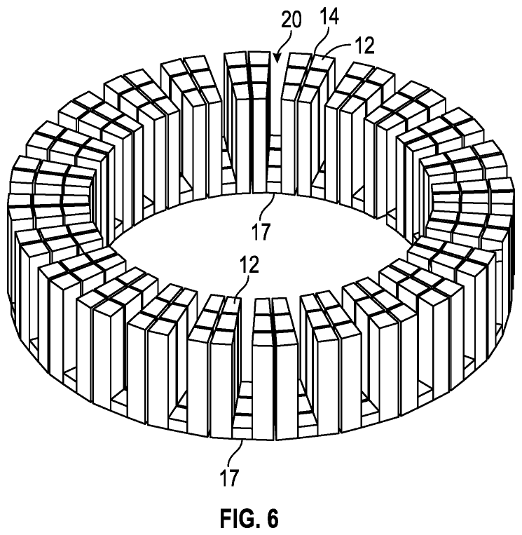

FIG. 6 is a perspective view from above of a yoke used in an alternative embodiment of the method of the present invention.

Referring to FIGS. 1-5 of the drawings, there is shown a stator 10 of an electrical motor formed in accordance with the present invention. The stator 10 is annular and is formed by successfully printing layers e.g. 24A-24W (see FIG. 2) in the direction of the axis of the stator 10, from one axial end thereof to the other. Initially, bottom end layers e.g. 24A-24C are deposited, the layers comprising regions of copper or other conductive material that form connections 17 between conductors 12 of the stator 10.

A plurality of conductors 12 are then formed by printing successive layers e.g. 24D-24T, each layer comprising a plurality of conductive regions of the conductive material, which are electrically isolated from each other and which form portions of respective conductors 12 of the stator 10, each conductive region of each successive layer e.g. 24K partially overlying the conductive region of the respective conductor in the previous layer e.g. 24J and being in an electrical and mechanical contact therewith, so as to form a plurality of elongate conductors 12 which are electrically isolated from each other. Adjacent conductors 12 are electrically isolated from adjacent conductors by gaps 14 which may comprise air. In an alternative embodiment, the gaps 14 may comprise an insulative material which is printed in layers at the same time as the conductors 12. The insulative material may surround each conductor 12 and it may partly or completely fill the gaps 14. The gaps may be filled with insulative material after the layers have been deposited.

The stator 10 comprises a laminated annular yolk or former 11 having radially-extending teeth 13. The yolk 11 is formed by printing a region of yolk material in each successive layer e.g. 24D-24T, the region of former material being electrically isolated from the conductive regions in each layer by air and/or the insulative material around the conductors 12. The yoke 11 is formed by successively depositing layers 15 of a first soft-magnetic former material and layers 16 of an insulative former material to form a laminated structure. Each region of former material of each successive layer overlies the respective region of former material in the previous layer and is in mechanical contact therewith to form a unitary former 11 having the desired cross-sectional shape.

So-called slots 26 are formed between the teeth 13 of the yolk 11 and the properties of the soft-magnetic material may be varied, for example to form the teeth 13 of the yoke 11 from a more expensive soft-magnetic material having a high saturation flux density than the rest of the yoke 11. The conductors 12 in each slot 26 are printed to have equal cross-sectional areas and their shape is selected, so that the conductors 12 fit closely within the area of the slots 26 without any unnecessary air gaps, thereby maximising the fill-factor of the slots 26. Once the final layer e.g. 26s having the conductors 12 is deposited, the top end layers e.g. 24t, 24u are deposited which comprise regions of copper or other conductive material that form connections 17 between conductors 12 of the stator 10. Layers forming interconnections 18 between the conductors 12 and supply terminals (not shown) may be deposited by printing.

Layers forming interconnections 19 to other phases of the stator 10 may also be deposited.

The layers may be printed to provide cooling ducts 50, which can extend along the conductors 12, adjacent the conductors 12 and/or through the former 11.

In use, current i flows into the motor from a supply terminal (not shown) and along an interconnection 18 to one of the conductors 12. The current i then flows down the conductor 12 inside one slot 26 and then along a connection 17 which extends under a tooth 13 of the laminated former 11. The current i then flows up the conductor 12 inside the slot 26 on the opposite side of the tooth 13 and then along a connection 17 which extends over the tooth 13 to another conductor 12. This process then and it will be appreciated that the motor of FIG. 1 effectively has nine winding turns formed by printing.

Referring to FIG. 6 of the drawings, in an alternative embodiment the bottom end connections 17 and the conductors 12 of the stator are printed without a core. The printed conductors 12 can then be engaged with a pre-formed core (not shown), whereupon the assembly can be over-printed to form the necessary connections and interconnections as hereinbefore described.

The present invention allows the stator, rotor (not shown) and other components of the motor to be printed in a similar manner and it will be appreciated that motors and other electromagnetic devices having can be printed quickly and on demand.

The present invention thus provides a method of forming an electrical motor, generator or other electromagnetic device by 3-D printing, wherein layers e.g. 24c-24s are successively deposited which comprise conductive regions and regions of a laminated, core, yoke or other former 11, so as to build up a plurality of conductors 12 extending inside spaces 26 in the former 11. The conductors 12 are interconnected at their ends to form a winding-like structure in or around the former 11 or a part thereof. The method enables each space 26 available in the former 11 to be filled with conductors 12, thereby maximising the efficiency of the device.

1. A method of forming an electromagnetic device, the method comprising depositing successive conductor layers, each deposited layer comprising a plurality of conductive regions of said conductive material which are electrically isolated from each other and which form portions of respective conductors of the device, each conductive region of each successive layer at least partially overlying the conductive region of the respective conductor in an adjacent layer and being in electrical and mechanical contact therewith to form a plurality of elongate conductors which are electrically isolated from each other, each layer comprising at least one region of a former material which is electrically isolated from the conductive regions, each region of former material of each successive layer overlying the respective region of former material in an adjacent layer and being in mechanical contact therewith to form an elongate former which is electrically isolated from the conductors and which co-extends with the conductors, the former being formed by sequentially depositing layers of a ferromagnetic material and layers of an insulative material to form a laminated structure, wherein the layers of ferromagnetic material are deposited to provide a plurality of varying magnetic properties in respective regions of the former.

2. A method as claimed in claim 1, in which conductive regions of the layer are deposited to have equal cross-sectional areas to at least some of the other regions in that layer.

3. A method as claimed in claim 1, in which ends of some conductors are interconnected to the ends of other conductors by interconnections to form turns of the electromagnetic device.

4. A method as claimed in claim 3, in which the interconnections are formed by depositing successive interconnection layers, each layer comprising a plurality of regions of conductive material which are electrically isolated from each other and which form portions of respective interconnections of the device, each region of each successive layer overlying the region of the respective interconnection in an adjacent layer and being in electrical and mechanical contact therewith to form a plurality of interconnections which are electrically isolated from each other and electrically connected to an end of at least one elongate conductor.

5. (canceled)

6. A method as claimed in claim 1, in which the ends of some conductors are connected to connections which, in use, convey current to and/or from the conductors, the connections being formed by depositing successive connection layers, each layer comprising a plurality of regions of conductive material which are electrically isolated from each other and which form portions of respective connections of the device, each region of each successive layer overlying the region of the respective connection in the adjacent layer and being in electrical and mechanical contact therewith to form a plurality of connections which are electrically isolated from each other and electrically connected to an end of at least one elongate conductor.

7. A method as claimed in claim 1, in which each conductor layer is deposited to provide at least one space in which no material is deposited, each space of each successive conductor layer overlying the respective space in the adjacent layer to form an elongate void which co-extends with the conductors.

8. (canceled)

9. (canceled)

10. (canceled)

11. (canceled)

12. A method as claimed in claim 1, in which the ferromagnetic material is treated to align or refine the magnetic domains and or grains in a preferred magnetic circuit direction.

13. (canceled)

14. A method as claimed in claim 1, comprising depositing said successive conductor layers, each conductive region being surrounded by an insulative region of insulative material which electrically isolates each conductive region from adjacent regions in the layer, each insulative region of each successive layer overlying the respective insulative region in the adjacent layer to form an insulative surround around each conductor.

15. A method as claimed in claim 1, comprising depositing said successive conductor layers, each layer comprising at least one wall region of a material which surrounds a space, each walled region of each successive layer overlying the respective walled region in the adjacent layer to form a duct.

16. (canceled)

17. (canceled)

18. A method as claimed in claim 1, the method comprising forming an electrical machine having an axis of rotation, the layers being successively deposited in the direction of the axis of rotation of the machine.

19. (canceled)

20. (canceled)

21. (canceled)

22. (canceled)

23. (canceled)
